(19) United States
(12) Patent Application Publication
(10) Pub. No.: US 2026/0087534 A1
(43) Pub. Date: Mar. 26, 2026

(54) USING A MACHINE-LEARNING MODEL TO GENERATE SUBSEQUENT ORDERS FOR PREVIOUSLY UNOBTAINED ITEMS

(71) Applicant: Maplebear Inc., San Francisco, CA (US)

(72) Inventors: Sonal Jain, Sunnyvale, CA (US); Karuna Ahuja, San Francisco, CA (US)

(21) Appl. No.: 18/893,843

(22) Filed: Sep. 23, 2024

(51) Int. Cl. G06Q 30/0601; G06N 20/00; G06Q 10/087

(52) U.S. Cl. CPC G06Q 30/0631; G06N 20/00; G06Q 10/087

(57) ABSTRACT

An online system generates subsequent orders for users following failed attempts to purchase items. The online system receives a request to fulfill an order from a user device. The online system determines that an item from the order is unable to be fulfilled and generates a failed fulfillment signal for the item associated with the user. At a later time, the online system automatically generates a set of items for a subsequent order for the user, the set of items including at least one item substantially similar to the item that was unable to be fulfilled and predicted by a machine-learned model to be available. The online system transmits a notification to the user that the set of items is available for fulfillment.

### BACKGROUND

Out of stock items can be detrimental to customer satisfaction of online orders, particularly in cases where an order has already been placed and it is discovered later that an item in the order is not available (e.g., out of stock, not available at their location, not able to be found).

Conventionally, if an item is not available, the item may be substituted with a different item, or the item may be refunded and not received. However, particularly in the case of refunded items, the customer may subsequently still be interested in the unreceived items but may not remember to add them to a new order or to check for them when they are available again. This is especially true if the unavailable item or items are not usual staples for the customer or if the customer has never purchased the item, as the unavailable item may not be automatically recommended based on purchase history.

As such, although there may be a high chance that the customer is still interested in purchasing the items, conventional systems do not include a mechanism to recommend the item once it is available.

### SUMMARY

In accordance with one or more aspects of the disclosure, an online system uses a machine-learned model to predict item availability for item recommendations following failed attempts to purchase those items or similar items. The online system may track items that were part of shopping lists of a user (e.g., a customer), but were later found to be unavailable and were not fulfilled as part of orders corresponding to the shopping lists. The online system may associate a failed fulfillment signal with the unavailable items, the failed fulfillment signal indicating a customer desire to purchase the unavailable items. The failed fulfillment signal may indicate a short-term desire, e.g., based on an immediate time period associated with the attempted purchase.

The online system may use one or more machine-learned models to automatically generate one or more items for a subsequent order for the user based on failed fulfillment signals. The subsequent orders may include the item once it is predicted to be available again by a machine-learned model or may include an item similar to the unavailable item that is available. The online system may transmit the subsequent order to the user as suggested items that are currently available for fulfillment.

Use of the failed fulfillment signal to generate subsequent orders for users enables the online system to better identify and meet customer needs that might not otherwise be recognized by conventional systems.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is an example sequence diagram describing generating orders based on failed fulfillment signals, in accordance with one or more embodiments.

FIG. 4 is an example interface for an online system with items available to be added to an order, in accordance with one or more embodiments.

FIGS. 5A-5B are example chat interfaces between a user of the online system and a picker, in accordance with one or more embodiments.

FIGS. 6A-6B are example interfaces showing subsequent orders generated by the online system responsive to a failed fulfillment signal, in accordance with one or more embodiments.

FIG. 7 is a flowchart for a method of generating orders based on failed fulfillment signals, in accordance with one or more embodiments.

### DETAILED DESCRIPTION

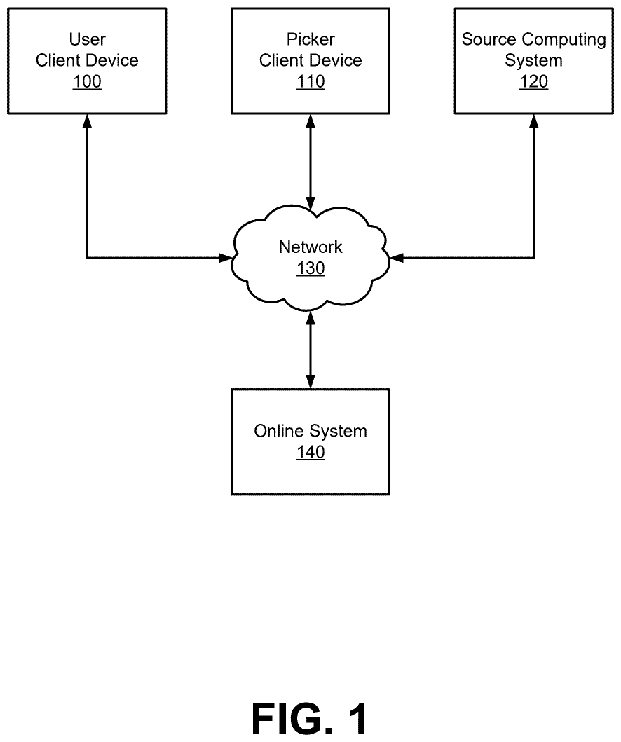

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered.

Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user.

The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

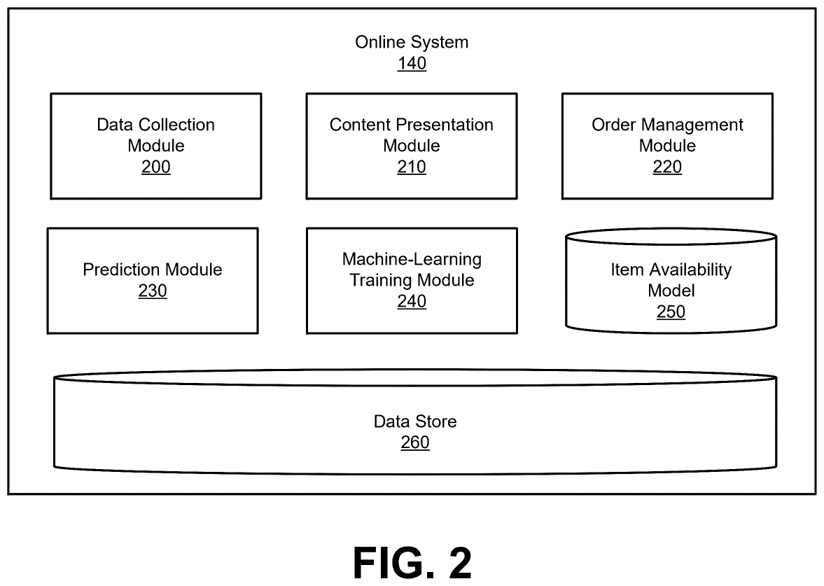

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with one or more embodiments. The system architecture illustrated in FIG. 2 includes a data collection module 200, a content presentation module 210, an order management module 220, a prediction module 230, a machine-learning training module 240, an item availability model 250, and a data store 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 260. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 260.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate replacement items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

In some embodiments, the prediction module 230 determines a mismatch between items on a shopping list and items actually fulfilled in a corresponding order. For example, a user conducting an in-person order (e.g., via smart cart) may have had saffron on their shopping list, but was unable to find it in the retailer location and/or it may have been unavailable at the retailer location. As such, while the shopping list included saffron, no saffron was purchased when the order was finalized, thereby resulting in a mismatch between items on the shopping list and the items actually fulfilled as part of the order. In another example, the prediction module 230 may receive, after the user has already placed an order for items on a shopping list for a retailer location, an indication that a requested item from the order is unavailable at the retailer location. For example, a picker assigned to the order may discover that the requested item is unavailable at the requested source location (e.g., retailer location ran out of stock of the item after the order had been finalized), and use the picker client device 110 to provide the indication to the online system 140. The prediction module 230 may use the indication to determine the mismatch between the items on the shopping list and items fulfilled in the order.

The prediction module 230 tracks items that were part of shopping lists of the user but were later found to be unavailable and were not fulfilled as parts of orders corresponding to the shopping lists. In some embodiments, the prediction module 230 generates a failed fulfillment signal for the unfulfilled item(s) that is associated with the user of the online system 140. The failed fulfillment signal represents a predicted desire by the user to purchase the item, wherein the predicted desire may be different or greater than other possible signals due to the user having already attempted to complete an order including the item. In some embodiments, the failed fulfillment signal may decay or expire after a set time period (e.g., a week after the failed fulfillment signal is generated, 48 hours after the failed fulfillment signal is generated, etc.). In other embodiments, the failed fulfillment signal may decay or expire responsive to the user placing a subsequent order including the item associated with the failed fulfillment signal and the subsequent order being completed, e.g., the user successfully receiving the previously unavailable item.

In other embodiments, the prediction module 230 may track the unfulfilled/unavailable items in another way. For example, the prediction module 230 may add the unfulfilled items to a database of tracked unfulfilled items, wherein the tracked unfulfilled items are associated with the user on the online system 140.

In some embodiments, the prediction module 230 applies an item availability model 250 to predict when items with a failed fulfillment signal are currently in stock at a warehouse or retailer location accessible to the user. In some embodiments, the prediction module 230 applies the item availability model 250 at a set interval (e.g., once a day for each item with a failed fulfillment signal, at 12 hour increments after the failed fulfillment signal is generated). In other embodiments, the prediction module 230 may coordinate with the data collection module 200 to determine when items with a failed fulfillment signal are available for the user. In other embodiments, the prediction module 230 may apply the item availability model 250 responsive to a user accessing the online system 140 after an order is unable to be fulfilled.

The prediction module 230 may generate one or more items for the user as a subsequent order based on failed fulfillment signals. In some embodiments, the subsequent order includes the item that was previously unable to be fulfilled but is predicted by the item availability model 250 to be available again. In other embodiments, the subsequent order includes one or more items that are substantially similar to the item, e.g., such that the substantially similar item may be a replacement item for the previously unfulfilled item. The one or more items for the subsequent order may be predicted to be available at the same warehouse or retailer location, e.g., having come back into stock, or may be predicted to be available at a different warehouse or retailer location.

The prediction module 230 may select one or more other items for inclusion in the subsequent order. In some embodiments, the one or more other items may be items commonly paired with the previously unfulfilled item (e.g., a pie crust with apples, waffle cones with ice cream) based on prior orders by the user or by other users of the online system 140. In other embodiments, the one or more other items may be items previously ordered by the user.

The prediction module 230 may provide the generated set of items to the user via the user client device 100 associated with the user. In some embodiments, the prediction module 230 may also instruct the user client device 100 to present the generated set of items in a particular way, e.g., within a shopping cart interface of the user, within a chat interface between the user and the online system and/or a picker, as part of a carousel, in a separate section than item recommendations for previously purchased items, during a checkout process, or the like.

The machine-learning training module 240 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 240 generates the set of parameters (e.g., the particular values of the parameters) for a machine-learning model by “training” the machine-learning model. Once trained, the machine-learning model uses the set of parameters to transform inputs into outputs.

The machine-learning training module 240 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 240 may apply an iterative process to train a machine-learning model whereby the machine-learning training module 240 updates parameter values of the machine-learning model based on each of the set of training examples. The training examples may be processed together, individually, or in batches. To train a machine-learning model based on a training example, the machine-learning training module 240 applies the machine-learning model to the input data in the training example to generate an output based on a current set of parameter values. The machine-learning training module 240 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 240 updates the set of parameters for the machine-learning model based on the score generated by the loss function. For example, the machine-learning training module 240 may apply gradient descent to update the set of parameters.

In some embodiments, the machine-learning training module 240 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 240 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

As previously noted, the online system 140 uses an item availability model 250 to predict the availability of items. An item availability model 250 is a machine-learning model that is trained to predict the availability of an item at a retailer location. For example, the item availability model 250 may be trained to predict a likelihood that an item is available at a retailer location or may predict an estimated number of items that are available at a retailer location. In some embodiments, the item availability model 250 may be trained to predict a value or approximate value of items available at a retailer location, while in other embodiments, the item availability model 250 may be trained to predict a binary availability for items, e.g., whether the item is likely to be available or not.

The item availability model, or “availability model,” is described in detail in U.S. application Ser. No. 17/570,038, filed on Jan. 6, 2022, which is hereby incorporated by reference in its entirety.

The data store 260 stores data used by the online system 140. For example, the data store 260 stores user data, item data, order data, and picker data for use by the online system 140. The data store 260 also stores trained machine-learning models trained by the machine-learning training module 240. For example, the data store 260 may store the set of parameters for a trained machine-learning model on one or more non-transitory, computer-readable media. The data store 260 uses computer-readable media to store data, and may use databases to organize the stored data.

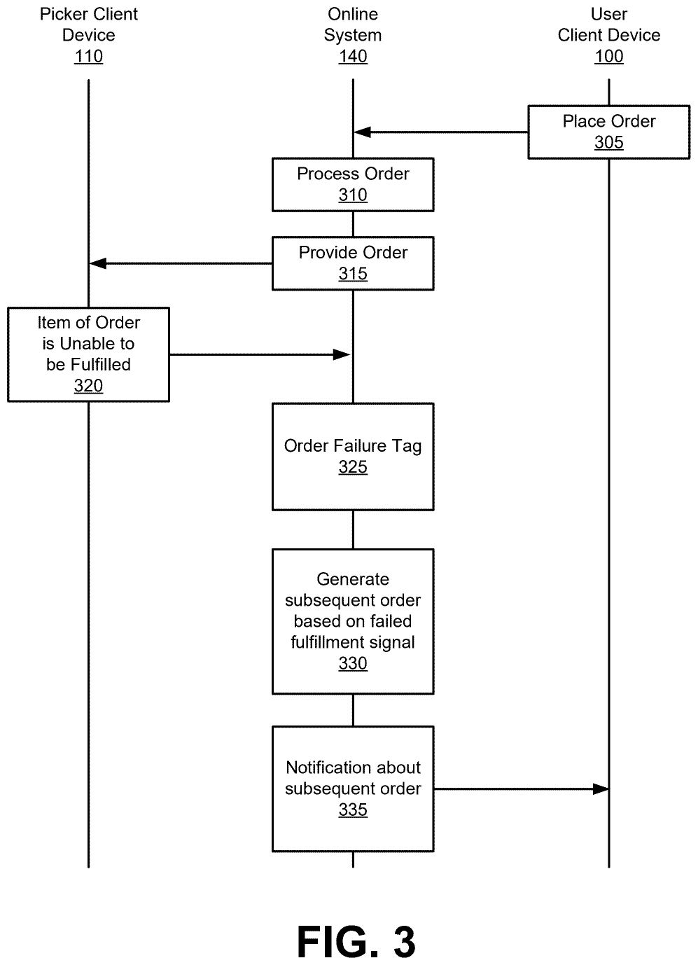

FIG. 3 is an example sequence diagram describing generating orders based on failed fulfillment signals, in accordance with one or more embodiments. A user of the online system 140 places an order 305 from a user client device 100. The order includes one or more items. In some embodiments, the one or more items are predicted to be in stock by the online system 140 at the time that the order is placed, e.g., by preventing users of the online system from ordering items that are not predicted to be in stock. The order may be associated with other information, such as, for example, a requested warehouse or retail location at which to fulfill the order, a requested delivery time or instructions, and the like.

The online system 140 processes the order 310 and provides the order 315 for fulfillment to a picker via a picker client device 110. The picker may determine that at least one item of the order is unable to be fulfilled 320. Items may be unable to be fulfilled if they are out of stock at a warehouse or retailer location (or are misplaced or otherwise unable to be found by the picker). The picker transmits a message via the picker client device 110 to the online system 140 indicating that the item was not fulfilled. In some embodiments, the message is transmitted via a chat interface between the picker and the user. In various embodiments, the online system 140 may recommend one or more replacement items for the unfulfilled item. Users of the online system 140 may elect to receive a replacement item to take the place of the unfulfilled item. However, in cases where no suitable replacement item is able to be found, the unfulfilled item is removed from the order. The online system 140 generates and stores an order failure tag 325 responsive to the unfulfilled item being removed and/or responsive to a refund for the unfulfilled item being provided to the user. The order failure tag 325 is stored in connection with the user's account and the items that was not able to be fulfilled.

Based on the failed fulfillment signal and an item availability model, the online system 140 generates 330 a set of items for a subsequent order. In some embodiments, the online system 140 generates the set of items for the subsequent order responsive to the user accessing the online system after the previous order is unable to be fulfilled. In other embodiments, the online system 140 generates the set of items for the subsequent order responsive to an item (associated with a failed fulfillment signal) that is subsequently predicted to be available after the previous order is unable to be fulfilled. The set of items includes at least one item substantially similar to (and may be the same as) the previously unfulfilled item. The item is predicted by the item availability model to be available or may include the previously unfulfilled item that is now predicted by the item availability model to have become available. In some embodiments, the set of items additionally includes one or more items that are commonly paired with the previously unfulfilled item and/or one or more items that are historically purchased by the user of the online system 140.

The online system 140 transmits a notification 335 about the generated subsequent order to the user client device 100. In some embodiments, the notification may be one or more of an email, text message, alert or message provided on the online system 140, or the like. The notification may appear within or direct the user to any suitable interface for adding the generated set of items to the user's cart, placing or confirming the subsequent order, or shopping for additional items on the online system 140. In some embodiments, the notification comprises an interactable element for confirming the subsequent order.

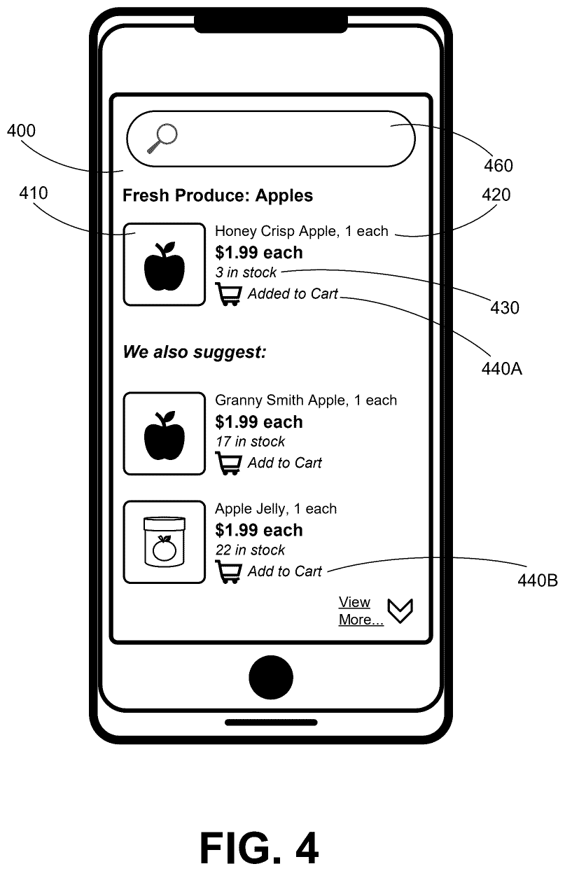

FIG. 4 is an example interface for an online system 140 with items available to be added to an order, in accordance with one or more embodiments. The items may appear in various interfaces of the online system 140, including interfaces not discussed or shown here, and may appear in different orientations, layouts, and in association with different forms of media and information than shown here.

The interface 400 illustrates a simplified selection interface. The selection interface 400 may be a homepage or main interface of the online system 140 or may be a search interface presented to users responsive to a search query being input to the online system. In some embodiments, the selection interface 400 may be a carousel interface including one or more carousels, which are scrollable lists of items (e.g., matched items within a group represented by the carousel) rather than a vertically scrolling list of items as shown.

The selection interface 400 includes one or more items. Each item is represented by information associated with the item and/or with actions that may be taken by a viewing user. For example, each item may be represented by display content 410, which may be static or dynamic images showing the item, as well as a name 420 describing the item, a price for each item, and an interactable element 440A, B enabling a user to add an item to an order (or indicating that an item has been added to a pending order). In some embodiments, the items may additionally be associated with a stock number 430 indicating a predicted availability for the item. In various embodiments, the selection interface 400 may additionally include a search bar 460 in which to input a new search query, options to navigate to other interfaces of the online system 140 such as a “View Cart” icon to view items currently added to a user's order, one or more scrollable carousels or lists in which additional items may be viewed, etc.

In embodiments in which the selection interface 400 includes stock numbers 430 indicating predicted availability for items, the stock numbers may be predicted by the item availability model 250. In one or more embodiments, the online system 140 may select items for presentation on the selection interface 400 based at least in part on the predicted stock numbers (e.g., weighting items with higher predicted stock higher than items with low predicted stock or items predicted to be unavailable or out of stock). In one or more embodiments, the online system 140 may include different elements on the selection interface 400 based at least in part on the predicted stock numbers (e.g., removing an “Add to Cart” element for items predicted to be out of stock) so as to reduce the likelihood of users placing orders for items that are unable to be fulfilled.

In some cases, items may be included in orders that are later discovered to be unavailable. Predicted stock numbers by the online system 140 may be inaccurate, or pickers may be unable to locate items at warehouses while fulfilling orders. When items are unable to be fulfilled according to orders, users of the online system 140 may elect to select a replacement item or to remove the unavailable item from the order to receive a refund.

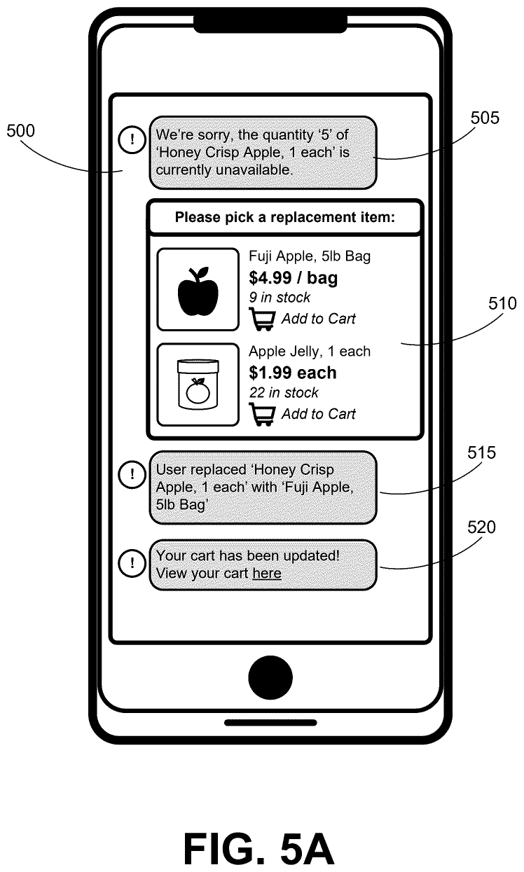

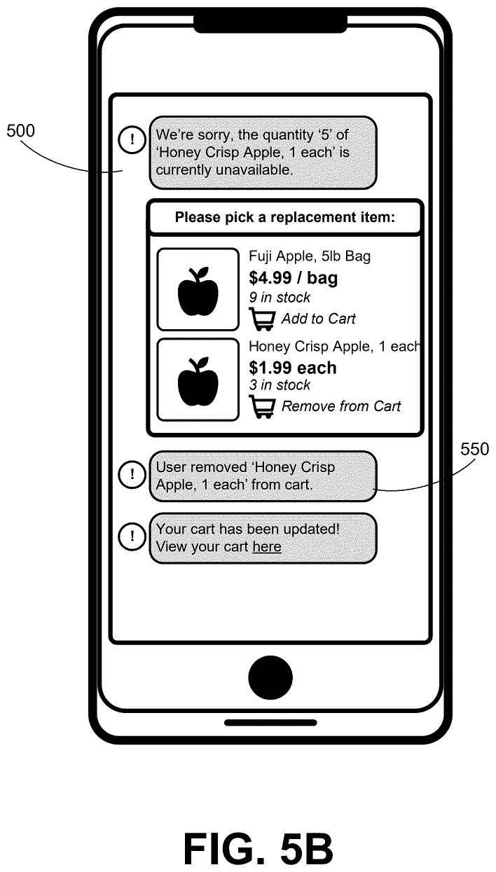

FIGS. 5A-5B are example chat interfaces between a user of the online system and a picker, in accordance with one or more embodiments. In some embodiments, a chat interface 500 is generated or initiated responsive to a picker being assigned to fulfill an order for a user of the online system 140. Pickers and users may use the chat interface 500 to communicate while the order is being fulfilled, e.g., to address replacement items, item preferences, issues with locating or delivering fulfilled orders, estimates as to expected wait times, and the like. In various embodiments, the chat interface 500 may enable pickers and users to type directly to each other. In other embodiments, the chat interface 500 may populate options for the user and picker by which to communicate.

In the example of FIG. 5A, a picker at a warehouse determines that an item (“Honey Crisp Apple, 1 each”) in an order being fulfilled is unavailable and transmits a message 505 to the user associated with the order.

Responsive to the message 505, the online system 140 may generate candidate replacement items based on the unavailable item. As discussed in conjunction with FIG. 2, candidate replacement items may be items within an item category considered to be equivalent to each other, such that they may function as replacements. Per the example of FIG. 5A, different types of apples or apple products (“Honey Crisp Apple, 1 each,” “Fuji Apple, 5 lb Bag,” “Apple Jelly, 1 each”) may be different items having different quantities and descriptions, but these items may be in an “apple” item category. The online system 140 transmits a notification 510 enabling the user associated with the order to view the candidate replacement items and to select a suitable replacement item. In some embodiments, the candidate replacement items may be selected based at least in part on a predicted availability for each of the candidate replacement items, such that replacement items predicted to be out of stock or low in stock are not displayed as candidate replacement items.

Based on the notification 510, the user may elect to replace the unavailable item with a candidate replacement item. Responsive to a candidate replacement item being selected, the user's selection 515 is transmitted to the picker for fulfillment and the user cart containing the order is updated 520 to indicate the candidate replacement item.

In some cases, as in the example interface shown in FIG. 5B, users are unable to find a suitable replacement item or may elect not to receive a replacement item. Instead, the user elects to remove the unavailable item from the order, receiving a refund for the item in the placed order and transmitting a notification 550 to the picker that no replacement item was selected. When the online system 140 identifies that items were removed from an order due to being unavailable at the time of fulfillment, the online system 140 may generate a failed fulfillment signal for the unavailable item, the failed fulfillment signal indicating the user's interest in purchasing the unavailable item. In some embodiments, the online system 140 may generate a failed fulfillment signal for the unavailable item even if a replacement item is selected, as the originally ordered item may still be desired by the user.

Based on the failed fulfillment signal, the online system 140 may automatically generate one or more items for a subsequent order. In some embodiments, the online system 140 applies an item availability model 250 and predicts that the previously unavailable item is available for fulfillment, e.g., has been restocked at the warehouse or is available at a different warehouse or retail location. In other embodiments, the online system 140 may include an item similar to the unavailable item that is available, e.g., a replacement item. The generated subsequent orders may additionally include one or more other items, such as items determined by the online system 140 to be commonly paired with the unavailable item or items based on prior orders by the user.

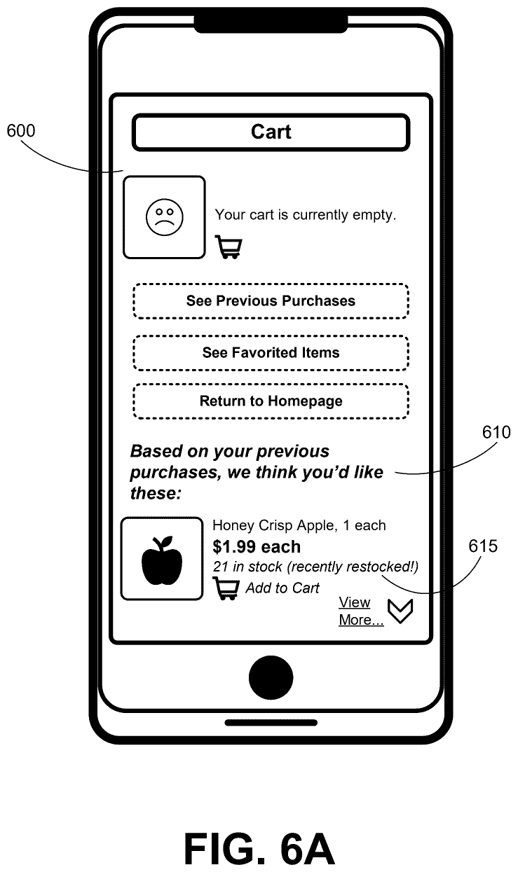

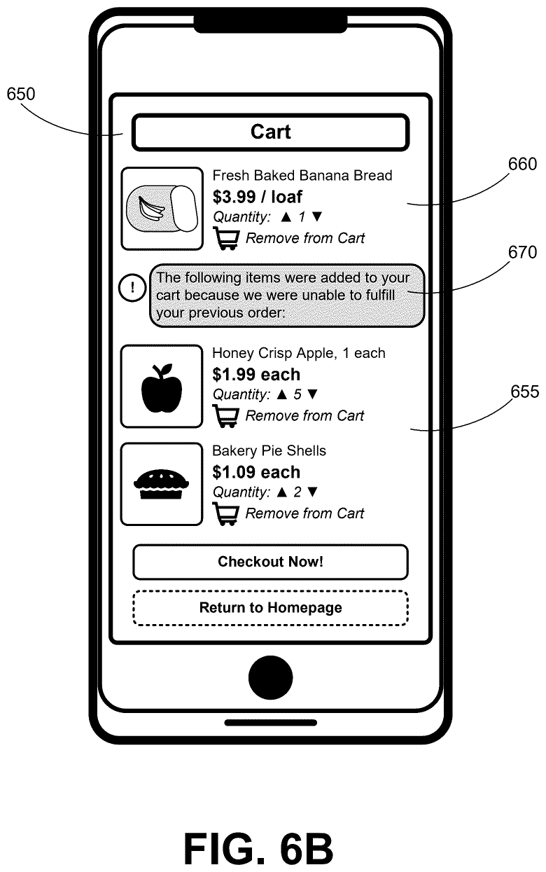

FIGS. 6A-B are example interfaces showing subsequent orders generated by the online system responsive to a failed fulfillment signal, in accordance with one or more embodiments. In the example interface of FIG. 6A, the online system 140 populates the subsequent order 610 as a section of an interface, e.g., the user cart interface 600. In other examples, the online system 140 may populate the subsequent order 610 within one or more other interfaces of the online system (e.g., as a carousel in a search interface of the online system, as a vertically scrollable section of a homepage of the online system, or the like). The subsequent order 610 includes one or more items based on the failed fulfillment signal. In some embodiments, the subsequent order 610 may include information 615 identifying the item for the failed fulfillment signal as having recently restocked or having become available and enabling a user of the online system 140 to add the items of the subsequent order directly to a new order for fulfillment.

In the example interface of FIG. 6B, the online system 140 populates the subsequent order 655 into the user cart interface 650. The user cart interface 650 may comprise one or more other items 660 added manually by the user, or the user cart interface 650 may be empty prior to the online system 140 populating the set of items of the subsequent order 655 into the cart. In some embodiments, the user cart interface 650 includes an element 670 specifying that the set of items of the subsequent order 655 are populated into the user cart based on a failed fulfillment signal, e.g., a previously unfulfilled order.

In various embodiments, the online system 140 may present the subsequent order in other interfaces not shown here. The subsequent order may comprise more or fewer items than shown in the example interfaces of FIGS. 6A-6B, and may be displayed with more, fewer, or different elements than shown in the example interfaces, e.g., to differentiate the set of items for the subsequent order from other items in the user's cart or from other suggested items in other interfaces of the online system 140.

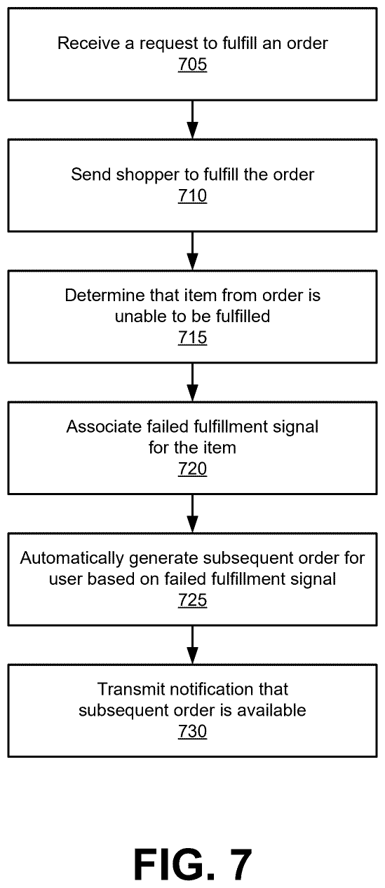

FIG. 7 is a flowchart for a method of generating orders based on failed fulfillment signals, in accordance with one or more embodiments. Alternative embodiments may include more, fewer, or different steps from those illustrated in FIG. 7, and the steps may be performed in a different order from that illustrated in FIG. 7. These steps may be performed by an online system (e.g., online system 140). Additionally, each of these steps may be performed automatically by the online system without human intervention.

The online system 140 receives 705 a request from a user device to fulfill an order of one or more items by a picker at a warehouse or retail location. At the time of the request, the one or more items included in the order may be predicted by the online system 140 to be in stock at the warehouse or retail location. The online system 140 sends 710 the order to the picker to be fulfilled.

The online system 140 determines 715 that at least one item included in the order is unable to be fulfilled. In some embodiments, the online system 140 receives a notification from the picker at the warehouse or retail location that the item is unable to be fulfilled, e.g., is out of stock or is unable to be located at the location. In other embodiments, the online system 140 receives updated stock information from the warehouse or updated stock predictions by an item availability model indicating that the item is unavailable.

The online system 140 associates 720 a failed fulfillment signal for the item with the user. The failed fulfillment signal indicates a customer desire to purchase the unavailable items, representative of the user having attempted to purchase the unavailable item and having been unable to. In some embodiments, the failed fulfillment signal may indicate a short-term desire, such that the failed fulfillment signal decays or expires after a set time period. For example, the failed fulfillment signal may decay or expire after twenty-four hours, after two days, after one week, etc. In other embodiments, the failed fulfillment signal may persist until a subsequent order is placed or until a subsequent order including the currently unavailable item is fulfilled.

The online system 140 automatically generates 725 a subsequent order for the user based on the failed fulfillment signal. In some embodiments, the online system 140 applies an item availability model to predict whether items included in the subsequent order are available. The subsequent order includes at least one item substantially similar to or the same as the unfulfilled item. For example, the subsequent order may include the item available at a different warehouse or retail location, or the item at the same warehouse or retail location available due to a restock. In another example, the subsequent order may include a new item similar to the unfulfilled item, e.g., such that the new item is predicted by the online system 140 to be a functional replacement for the unfulfilled item.

In some embodiments, the subsequent order may include one or more additional items based at least in part on the unfulfilled item. For example, the one or more additional items may be predicted by a machine-learning model to be commonly purchased with the unfulfilled item, e.g., vanilla ice cream (replacement item) is commonly purchased with a chocolate syrup (additional item). In another example, the one or more additional items may be based on one or more prior orders by the user.

The online system 140 transmits 730 a notification to the user device that the set of items is available for fulfillment. In some embodiments, the online system 140 automatically adds the set of items of the generated order to a cart for the user, and the notification includes an element to confirm the subsequent order, e.g., a button on an interface of the online system 140. In other embodiments, the online system 140 populates the set of items to an interface or part of an interface of the online system, e.g., a carousel for items associated with the unfulfilled item, and the notification includes a link to the interface or part of the interface.

In various embodiments, the online system 140 may preserve the failed fulfillment signal until the subsequent order including the item substantially similar to or the same as the unfulfilled item is completed, e.g., fulfilled by a picker of the online system. In other embodiments, the online system 140 may remove the failed fulfillment signal responsive to the user interacting with the notification about the set of items, regardless of whether the subsequent order is placed or not.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method comprising:
receiving, by an online system from a user device operated by a user, an order for an item;
sending an instruction message to a picker device operated by a picker, the instruction message causing the picker device to display an instruction to obtain the item from a source;
receiving, from the picker device, a response message that the picker was unable to obtain the item from the source;
storing an order failure tag, the order failure tag associated with an account of the user and the item;
at a later time, after receiving the response message that the picker was unable to obtain the item from the source, applying an item availability model to predict that the item is available, wherein the item availability model comprises a machine-learning model that is trained, using a set of training data from previous orders, to predict whether a particular item is available at a particular source;
generating a notification to order a set of items for the user based on the prediction that the item is available at the later time, wherein generating the notification comprises one of:
selecting, for the set of items, the item that is predicted by the item availability model to be available at the later time, or
selecting, for the set of items, another item based on a similarity of the other item to the item that is predicted by the item availability model to be available at the later time; and
transmitting, to the user device, the notification to order the set of items, causing the user device to display the notification.

2. The method of claim 1, wherein the item availability model is trained by:
applying the item availability model to training data from previous orders to output predictions of whether items were available for the previous orders;
comparing the predictions to indications in the training data of whether the items were available for the previous orders; and
updating parameters of the item availability model based on the comparing.

3. The method of claim 1, further comprising:
before sending the instruction message to the picker device, applying the item availability model to predict that the item is available at the source.

4. The method of claim 1, wherein applying the item availability model to predict that the item is available comprises applying the item availability model to predict that the item is available from another source.

5. The method of claim 1, wherein transmitting the notification to order the set of items comprises transmitting, to the user device, a user interface element to place a subsequent order for the set of items.

6. The method of claim 1, further comprising:
removing the stored order failure tag after a predetermined time period.

7. The method of claim 1, further comprising:
receiving an indication that the user ordered the item; and
responsive to receiving the indication that the user ordered the item, removing the stored order failure tag.

8. The method of claim 1, wherein receiving the response message that the picker was unable to obtain the item from the source comprises receiving, from the picker device while located at the source, the response message in a chat interface.

9. The method of claim 1, wherein generating the notification to order a set of items for the user based on the prediction that the item is available at the later time comprises generating the notification responsive to the user device accessing the online system after receiving the response message that the picker was unable to obtain the item from the source.

10. A computer program product comprising a non-transitory computer-readable storage medium having instructions encoded thereon that, when executed by a processor, cause the processor to perform steps comprising:
receiving, by an online system from a user device operated by a user, an order for an item;
sending an instruction message to a picker device operated by a picker, the instruction message causing the picker device to display an instruction to obtain the item from a source;
receiving, from the picker device, a response message that the picker was unable to obtain the item from the source;
storing an order failure tag, the order failure tag associated with an account of the user and the item;
at a later time, after receiving the response message that the picker was unable to obtain the item from the source, applying an item availability model to predict that the item is available, wherein the item availability model comprises a machine-learning model that is trained, using a set of training data from previous orders, to predict whether a particular item is available at a particular source;
generating a notification to order a set of items for the user based on the prediction that the item is available at the later time, wherein generating the notification comprises one of:
selecting, for the set of items, the item that is predicted by the item availability model to be available at the later time, or
selecting, for the set of items, another item based on a similarity of the other item to the item that is predicted by the item availability model to be available at the later time; and
transmitting, to the user device, the notification to order the set of items, causing the user device to display the notification.

11. The non-transitory computer-readable storage medium of claim 10, wherein the item availability model is trained by:
applying the item availability model to training data from previous orders to output predictions of whether items were available for the previous orders;
comparing the predictions to indications in the training data of whether the items were available for the previous orders; and
updating parameters of the item availability model based on the comparing.

12. The non-transitory computer-readable storage medium of claim 10, wherein the non-transitory computer-readable storage medium further has instructions encoded thereon that, when executed by a processor, cause the processor to perform steps comprising:
before sending the instruction message to the picker device, applying the item availability model to predict that the item is available at the source.

13. The non-transitory computer-readable storage medium of claim 10, wherein applying the item availability model to predict that the item is available comprises applying the item availability model to predict that the item is available from another source.

14. The non-transitory computer-readable storage medium of claim 10, wherein transmitting the notification to order the set of items comprises transmitting, to the user device, a user interface element to place a subsequent order for the set of items.

15. The non-transitory computer-readable storage medium of claim 10, wherein the non-transitory computer-readable storage medium further has instructions encoded thereon that, when executed by a processor, cause the processor to perform steps comprising:
removing the stored order failure tag after a predetermined time period.

16. The non-transitory computer-readable storage medium of claim 10, wherein the non-transitory computer-readable storage medium further has instructions encoded thereon that, when executed by a processor, cause the processor to perform steps comprising:
receiving an indication that the user ordered the item; and
responsive to receiving the indication that the user ordered the item, removing the stored order failure tag.

17. The non-transitory computer-readable storage medium of claim 10, wherein receiving the response message that the picker was unable to obtain the item from the source comprises receiving, from the picker device while located at the source, the response message in a chat interface.

18. The non-transitory computer-readable storage medium of claim 10, wherein generating the notification to order a set of items for the user based on the prediction that the item is available at the later time comprises generating the notification responsive to the user device accessing the online system after receiving the response message that the picker was unable to obtain the item from the source.

19. A system comprising:
one or more processors that execute instructions; and
a non-transitory computer-readable storage medium having instructions, executable by the one or more processors, for:
receiving, by an online system from a user device operated by a user, an order for an item;
sending an instruction message to a picker device operated by a picker, the instruction message causing the picker device to display an instruction to obtain the item from a source;
receiving, from the picker device, a response message that the picker was unable to obtain the item from the source;
storing an order failure tag, the order failure tag associated with an account of the user and the item;
at a later time, after receiving the response message that the picker was unable to obtain the item from the source, applying an item availability model to predict that the item is available, wherein the item availability model comprises a machine-learning model that is trained, using a set of training data from previous orders, to predict whether a particular item is available at a particular source;
generating a notification to order a set of items for the user based on the prediction that the item is available at the later time, wherein generating the notification comprises one of:
selecting, for the set of items, the item that is predicted by the item availability model to be available at the later time, or
selecting, for the set of items, another item based on a similarity of the other item to the item that is predicted by the item availability model to be available at the later time; and
transmitting, to the user device, the notification to order the set of items, causing the user device to display the notification.

20. The system of claim 19, wherein the item availability model is trained by:
applying the item availability model to training data from previous orders to output predictions of whether items were available for the previous orders;
comparing the predictions to indications in the training data of whether the items were available for the previous orders; and
updating parameters of the item availability model based on the comparing.
